(19) United States
(12) Patent Application Publication
(10) Pub. No.: US 2026/0314621 A1
(43) Pub. Date: Oct. 15, 2026

(54) PLANT-BASED FAT TISSUE SUBSTITUTE

(71) Applicant: BUNGE SA, Geneva (CH)

(72) Inventors: Andrea Ching-Tzu Su STANGE, St. Charles, MO (US); Shawn Xiangqing PAN, St. Charles, MO (US)

(21) Appl. No.: 19/484,601

(22) PCT Filed: May 15, 2024
(86) PCT No.: PCT/EP2024/063398

§ 371 Date: Nov. 14, 2025

Related U.S. Application Data
(60) Provisional application No. 63/502,486, filed on May 16, 2023.

(30) Foreign Application Priority Data
Oct. 10, 2023 (EP) 23202748.2

(51) Int. Cl. A23D 7/005; A23D 7/01; A23D 7/05

(52) U.S. Cl. CPC A23D 7/0053; A23D 7/011; A23D 7/05

(57) ABSTRACT

The present disclosure is directed to plant-based intramuscular fat substitutes. In particular, it provides fat tissue substitutes that comprise starch, plant-based oil or fat and emulsifier with no or a limited amount of plant-based protein. The fat tissue substitute has improved stability and functional textures desirable for processing, such as for incorporating into food products. Also disclosed are processes for preparing the fat tissues substitutes, uses of the fat tissues substitutes, and food products comprising the fat tissues substitutes.

### FIELD OF THE INVENTION

The present disclosure is directed to plant-based intramuscular fat substitutes. In particular, it provides fat tissue substitutes that comprise starch, plant-based oil or fat and an emulsifier with no or limited amount of plant-based protein. These substitutes exhibit having enhanced stability and functional textures, facilitating ease of processing and incorporation into various food products. Also disclosed are processes for preparing the fat tissue substitutes, uses of the fat tissue substitutes, and food products comprising the fat tissue substitutes.

### BACKGROUND OF THE INVENTION

Animal fat tissue is composed of liquid and solid fats encased within a proteinaceous connective tissue network that has unique rheological and physical properties. The microstructure of a meat fat tissue can be simplified as triglyceride droplets encapsulated within fat cells, which in turn are embedded in a strong physical connective tissue matrix. Such structures possess unique elastic and melting properties that are not replicable in the available plant-based food landscape.

Currently, fat tissue substitutes face significant challenges in replicating distinctive characteristics of animal fat tissue. In particular, there is a need for a fat tissue substitute that is (1) easy to be produced, (2) maintains stability during storage and processing, (3) gradually releases oil at a controlled rate during cooking, producing desired sizzling and browning reactions, and (4) retaining a desired marbled appearance and juiciness.

WO 2022/177943 discloses animal fat substitute compositions comprising an oil-in-water emulsion containing a mixture of one or more plant proteins and a plant-based oil or fat. However, it does not disclose any fat tissue substitute comprising starch with no or limited amounts of plant-based protein.

AU-A-79472/87 discloses water-in-oil emulsions with a reduced fat content suitable for frying. However, it does not disclose any fat tissue substitute suitable for plant-based meat applications.

US 2021/0259290, WO 2021/099506 and WO 2022/115289 disclose meat analogue products. However, they do not disclose any fat tissue substitute specifically designed as marbling fat to replace animal fat in plant-based meat applications.

WO 2022/164913 discloses materials and methods for producing plant-based meat replacement food products. However, it does not disclose any fat tissue substitute comprising plant-based oils or fats with the requirements as disclosed herein to achieve desirable textural and sensory properties.

There remains a need for a fat tissue substitute that (1) comprises starch, a plant-based oil or fat and emulsifier with no or limited amounts of plant-based protein, (2) addresses the above-noted textural and structural issues associated with existing substitutes, (3) exhibits desirable firmness while maintaining a stable emulsion structure, (4) can be easily processed to size down as marbling fat for plant-based meat applications, (5) improves marbling appearance, juiciness and oil leaking during cooking, (6) produces significant sizzling and does not stick to the pan during cooking, and/or (7) is stable and resilient during the freeze and thaw process for plant-based meat applications.

### SUMMARY OF THE INVENTION

In one aspect, the present disclosure is directed to a fat tissue substitute comprising: (i) a starch source; (ii) less than 1 wt % of a plant-based protein relative to the total weight of the fat tissue substitute; (iii) a plant-based oil or fat having a solid fat content from 15 to 45 at 21.1° C. and a solid fat content from 2 to 25 at 33.3° C.; wherein the solid fat content is measured on unstabilized fat according to AOCS Cd 16b-93; (iv) an emulsifier; and (v) water.

In another aspect, the present disclosure is directed to a process for making the fat tissue substitute as disclosed herein, the process comprising the steps of: a) providing a starch source, a plant-based oil or fat, an emulsifier, and optionally a plant-based protein; b) forming a mixture of the provided ingredients and water; c) emulsifying the mixture to obtain an emulsion; and d) crystallizing the obtained emulsion.

In yet another aspect, the present disclosure is directed to a fat tissue substitute obtainable by the process for making the fat tissue substitute as disclosed herein.

In a further aspect, the present disclosure is directed to a use of the fat tissue substitute as disclosed herein in a food product.

In yet another aspect, the present disclosure is directed to a food product comprising the fat tissue substitute as disclosed herein.

These and other features of the present disclosure will become apparent to one skilled in the art upon review of the following detailed description when taken in conjunction with the appended claims.

### DETAILED DESCRIPTION OF THE INVENTION

### Definitions

As used herein, articles such as “a” and “an” when used in a claim, are understood to mean one or more of what is claimed or described.

As used herein, the term “about” to modify a number is meant to include the number recited plus or minus 10%, preferably 5% or preferably 2%. Where legally permissible recitation of a value in a claim means about the value. Use of about in a claim or in the specification is not intended to limit the full scope of covered equivalents.

As used herein, the terms “include”, “includes” and “including” are meant to be non-limiting.

As used herein, the term “fat tissue substitute” refers to a composition capable of and/or suitable for substituting animal derived meat fat tissues in the products such as meat analogue which is a hydrated proteinaceous food product similar to meat in the aspects such as appearance, texture, color and/or flavor.

As used herein, the term “food product” means an edible product which is safe for consumption by people.

As used herein, the term “fat” refers to glyceride fats and oils containing fatty acid acyl groups and does not imply any particular melting point. The term “oil” is used synonymously with “fat”.

As used herein, the term “plant-based oil or fat” refers to an oil or fat that is not, and is not derived from, one or more animal fats. The plant-based oil or fat may be made from naturally occurring (i.e., in plants or other non-animal sources) or synthetic fats, fractions of naturally occurring or synthetic fats, or mixtures thereof, that satisfy the requirements defined herein. It is also preferred that the plant-based oil or fat in the fat tissue substitute as disclosed herein is, or is derived from, non-hydrogenated fats. The term “non-hydrogenated” means that the fat phase is not prepared from a fat that has been subjected to hydrogenation to convert unsaturated fatty acyl groups to saturated fatty acyl groups.

As used herein, the term “fatty acid” refers to straight chain saturated or unsaturated (including mono- and poly-unsaturated) carboxylic acids having from 8 to 24 carbon atoms. A fatty acid having x carbon atoms and y double bonds may be denoted Cx:y. For example, palmitic acid may be denoted C16:0 and oleic acid may be denoted C18:1. The fatty acid profile may be determined by fatty acid methyl ester analysis (FAME) using gas chromatography according to ISO 12966-2: 2014 and ISO 12966-4: 2015. Thus, unless otherwise specified, percentages of fatty acids in compositions (e.g., palmitic acid (C16:0), stearic acid (C18:0), oleic acid (C18:1) etc.) referred to herein include acyl groups such as tri-, di- and mono-glycerides and are based on the total weight of C8 to C24 fatty acid residues.

It is understood that the methods that are disclosed in the Examples section of the present application must be used to determine the respective values of the parameters of the inventions as described and claimed herein.

In all embodiments of the present disclosure, all percentages are by weight of the total composition, as evident by the context, unless specifically stated otherwise. All ratios are weight ratios, unless specifically stated otherwise, and all measurements are made at room temperature, such as 20° C. to 25° C., unless otherwise designated. Values of solid fat content (SFC) included herein are, unless otherwise dictated by context, a weight percentage (wt. %).

### Fat Tissue Substitute

The present disclosure is directed to a fat tissue substitute that comprises starch, a plant-based oil or fat and an emulsifier with no or a limited amount of plant-based protein. The fat tissue substitute exhibits improved stability and functional textures that facilitate ease of processing. Advantageously, the fat tissue substitute as disclosed herein has desirable firmness and a stable emulsion structure, making it convenient for production and ease of processing to size down as marbling fat for plant-based meat applications. Use in this way enhances marbling appearance and juiciness and reduces oil leakage.

The fat tissue substitute as disclosed herein preferably comprises from about 0.5 wt % to about 5 wt % of the starch source relative to the total weight of the fat tissue substitute, more preferably from about 1 wt % to about 4 wt % and even more preferably from about 1.5 wt % to about 3 wt %.

In a preferred aspect, the starch source in the fat tissue substitute as disclosed herein is selected from a group consisting of tapioca starch, tapioca flour, corn starch, corn flour, potato starch, pea starch, saga starch, rice flour, rice starch, wheat starch, wheat flour, mung bean starch, mung bean flour, sweet potato starch, modified starch, and combinations thereof. In a more preferred aspect, the starch source in the fat tissue substitute as disclosed herein is selected from a group consisting of corn starch, corn flour, derivatives thereof and mixtures thereof.

To improve process tolerance, the starch may be modified through techniques such as etherification, esterification or thermal inhibition. Examples of modified starches include phosphate crosslinked starch, adipate crosslinked starch, hydroxypropylated starch, acetylated starch, starch citrates, and succinate modified starch (including octenylsuccinate (OSA) modified starch). The pregelatinized starch or modified starch is particularly preferred as the starch source for the fat tissue substitute as disclosed herein. The term “pregelatinized starch” refers to a starch that has undergone a cooking and drying process, rendering it soluble in cold water. In another more preferred aspect, the starch source in the fat tissue substitute as disclosed herein is a pregelatinized corn starch.

In a preferred aspect, the fat tissue substitute as disclosed herein comprises from about 0.5 wt % to about 5 wt % of the starch source relative to the total weight of the fat tissue substitute, wherein the starch source is selected from a group consisting of tapioca starch, tapioca flour, corn starch, corn flour, potato starch, pea starch, saga starch, rice flour, rice starch, wheat starch, wheat flour, mung bean starch, mung bean flour, sweet potato starch, modified starch, and combinations thereof.

In a more preferred aspect, the fat tissue substitute as disclosed herein comprises from about 1 wt % to about 4 wt % of the starch source relative to the total weight of the fat tissue substitute, wherein the starch source is selected from a group consisting of tapioca starch, corn starch, corn flour, potato starch, and combinations thereof.

In an even more preferred aspect, the fat tissue substitute as disclosed herein comprises from about 1.5 wt % to about 3 wt % of the starch source relative to the total weight of the fat tissue substitute, wherein the starch source is pregelatinized corn starch.

In another even more preferred aspect, the fat tissue substitute as disclosed herein comprises from about 1.5 wt % to about 3 wt % of the starch source relative to the total weight of the fat tissue substitute, wherein the starch source is selected from a group consisting of corn starch, corn flour, derivatives thereof and mixtures thereof.

The fat tissue substitute as disclosed herein preferably comprises less than about 0.5 wt % of the plant-based protein relative to the total weight of the fat tissue substitute, and more preferably less than about 0.2 wt %. Even more preferably, the fat tissue substitute as disclosed herein is free or substantially free or essentially free of a plant-based protein.

Unless otherwise specified, the terms “substantially free” or “essentially free” as used herein refer to less than about 0.1 wt % of the plant-based protein, relative to the total weight of the fat tissue substitute.

The fat tissue substitute as disclosed herein preferably comprises from about 55 wt % to about 80 wt % of the plant-based oil or fat relative to the total weight of the fat tissue substitute, more preferably from about 60 wt % to about 75 wt % and even more preferably from about 65 wt % to about 70 wt %.

The plant-based oil or fat in the fat tissue substitute as disclosed herein preferably has a solid fat content (SFC) from 28 to 60 at 10.0° C., more preferably from 32 to 55 and even more preferably from 35 to 50; wherein the solid fat content is measured on unstabilized fat according to AOCS Cd 16b93.

The plant-based oil or fat in the fat tissue substitute as disclosed herein preferably has a solid fat content (SFC) from 18 to 40 at 21.1° C., more preferably from 20 to 35 and even more preferably from 21 to 30; wherein the solid fat content is measured on unstabilized fat according to AOCS Cd 16b93.

The plant-based oil or fat in the fat tissue substitute as disclosed herein preferably has a solid fat content (SFC) from 5 to 30 at 26.7° C., more preferably from 6 to 25 and even more preferably from 8 to 22; wherein the solid fat content is measured on unstabilized fat according to AOCS Cd 16b93.

The plant-based oil or fat in the fat tissue substitute as disclosed herein preferably has a solid fat content (SFC) from 3 to 22 at 33.3° C., more preferably from 4 to 18 and even more preferably from 4 to 15; wherein the solid fat content is measured on unstabilized fat according to AOCS Cd 16b93.

The plant-based oil or fat in the fat tissue substitute as disclosed herein preferably has a solid fat content from 0.5 to 15 at 40.0° C., more preferably from 1 to 12 and even more preferably from 1.5 to 10; wherein the solid fat content is measured on unstabilized fat according to AOCS Cd 16b93.

In a preferred aspect, the plant-based oil or fat in the fat tissue substitute as disclosed herein has a solid fat content (SFC) from 28 to 60 at 10.0° C.; an SFC from 18 to 40 at 21.1° C.; an SFC from 5 to 30 at 26.7° C.; an SFC from 3 to 22 at 33.3° C.; and an SFC from 0.5 to 15 at 40.0° C.; wherein the solid fat content is measured on unstabilized fat according to AOCS Cd 16b-93.

In a more preferred aspect, the plant-based oil or fat in the fat tissue substitute as disclosed herein has from a solid fat content (SFC) 32 to 55 at 10.0° C.; an SFC from 20 to 35 at 21.1° C.; an SFC from 6 to 25 at 26.7° C.; an SFC from 4 to 18 at 33.3° C.; and an SFC from 1 to 12 at 40.0° C.; wherein the solid fat content is measured on unstabilized fat according to AOCS Cd 16b-93.

In an even more preferred aspect, the plant-based oil or fat in the fat tissue substitute as disclosed herein has a solid fat content (SFC) from 35 to 50 at 10.0° C.; an SFC from 21 to 30 at 21.1° C.; an SFC from 8 to 22 solid fat content at 26.7° C.; an SFC from 4 to 15 at 33.3° C.; and an SFC from 1.5 to 10 solid fat content at 40.0° C.; wherein the solid fat content is measured on unstabilized fat according to AOCS Cd 16b-93.

The plant-based oil or fat in the fat tissue substitute as disclosed herein preferably has from about 3 wt % to about 20 wt % of palmitic acid (C16:0), more preferably from about 4 wt % to about 15 wt % and even more preferably from about 4 wt % to about 12 wt %; wherein said wt % is relative to the acids bound as acyl groups in glycerides in the fat composition and based on the total weight of C8 to C24 fatty acids.

The plant-based oil or fat in the fat tissue substitute as disclosed herein preferably has from about 15 wt % to about 55 wt % of stearic acid (C18:0), more preferably from about 20 wt % to about 50 wt % and even more preferably from about 25 wt % to about 45 wt %; wherein said wt % is relative to the acids bound as acyl groups in glycerides in the fat composition and based on the total weight of C8 to C24 fatty acids.

The plant-based oil or fat in the fat tissue substitute as disclosed herein preferably has from about 5 wt % to about 55 wt % of oleic acid (C18:1), more preferably from about 8 wt % to about 50 wt % and even more preferably from about 10 wt % to about 45 wt %; wherein said wt % is relative to the acids bound as acyl groups in glycerides in the fat composition and based on the total weight of C8 to C24 fatty acids.

The plant-based oil or fat in the fat tissue substitute as disclosed herein preferably has from about 3 wt % to about 45 wt % of linoleic acid (C18:2), more preferably from about 4 wt % to about 40 wt % and even more preferably from about 5 wt % to about 35 wt %; wherein said wt % is relative to the acids bound as acyl groups in glycerides in the fat composition and based on the total weight of C8 to C24 fatty acids.

In a preferred aspect, the plant-based oil or fat in the fat tissue substitute as disclosed herein has from about 3 wt % to about 20 wt % of palmitic acid (C16:0); from about 15 wt % to about 55 wt % of stearic acid (C18:0); from about 5 wt % to about 55 wt % of oleic acid (C18:1); and from about 3 wt % to about 45 wt % of linoleic acid (C18:2); wherein said wt % is relative to the acids bound as acyl groups in glycerides in the fat composition and based on the total weight of C8 to C24 fatty acids.

In a more preferred aspect, the plant-based oil or fat in the fat tissue substitute as disclosed herein has from about 4 wt % to about 15 wt % of palmitic acid (C16:0); from about 20 wt % to about 50 wt % of stearic acid (C18:0); from about 8 wt % to about 50 wt % of oleic acid (C18:1); and from about 4 wt % to about 40 wt % of linoleic acid (C18:2); wherein said wt % is relative to the acids bound as acyl groups in glycerides in the fat composition and based on the total weight of C8 to C24 fatty acids.

In an even more preferred aspect, the plant-based oil or fat in the fat tissue substitute as disclosed herein has from about 4 wt % to about 12 wt % of palmitic acid (C16:0); from about 25 wt % to about 45 wt % of stearic acid (C18:0); from about 10 wt % to about 45 wt % of oleic acid (C18:1); and from about 5 wt % to about 35 wt % of linoleic acid (C18:2); wherein said wt % is relative to the acids bound as acyl groups in glycerides in the fat composition and based on the total weight of C8 to C24 fatty acids.

In a preferred aspect, the plant-based oil or fat in the fat tissue substitute as disclosed herein has a solid fat content (SFC) from 28 to 60 at 10.0° C.; an SFC from 18 to 40 at 21.1° C.; an SFC from 5 to 30 at 26.7° C.; an SFC from 3 to 22 at 33.3° C.; and an SFC from 0.5 to 15 at 40.0° C.; wherein the solid fat content is measured on unstabilized fat according to AOCS Cd 16b-93; from about 3 wt % to about 20 wt % of palmitic acid (C16:0); from about 15 wt % to about 55 wt % of stearic acid (C18:0); from about 5 wt % to about 55 wt % of oleic acid (C18:1); and from about 3 wt % to about 45 wt % of linoleic acid (C18:2); wherein said wt % is relative to the acids bound as acyl groups in glycerides in the fat composition and based on the total weight of C8 to C24 fatty acids.

In a more preferred aspect, the plant-based oil or fat in the fat tissue substitute as disclosed herein has a solid fat content (SFC) from 32 to 55 at 10.0° C.; an SFC from 20 to 35 at 21.1° C.; an SFC from 6 to 25 at 26.7° C.; an SFC from 4 to 18 solid fat content at 33.3° C.; and an SFC from 1 to 12 at 40.0° C.; wherein the solid fat content is measured on unstabilized fat according to AOCS Cd 16b-93; from about 4 wt % to about 15 wt % of palmitic acid (C16:0); from about 20 wt % to about 50 wt % of stearic acid (C18:0); from about 8 wt % to about 50 wt % of oleic acid (C18:1); and from about 4 wt % to about 40 wt % of linoleic acid (C18:2); wherein said wt % is relative to the acids bound as acyl groups in glycerides in the fat composition and based on the total weight of C8 to C24 fatty acids.

In an even more preferred aspect, the plant-based oil or fat in the fat tissue substitute as disclosed herein has a solid fat content (SFC) from 35 to 50 at 10.0° C.; an SFC from 21 to 30 at 21.1° C.; an SFC from 8 to 22 at 26.7° C.; an SFC from 4 to 15 at 33.3° C.; and an SFC from 1.5 to 10 at 40.0° C.; wherein the solid fat content is measured on unstabilized fat according to AOCS Cd 16b-93; from about 4 wt % to about 12 wt % of palmitic acid (C16:0); from about 25 wt % to about 45 wt % of stearic acid (C18:0); from about 10 wt % to about 45 wt % of oleic acid (C18:1); and from about 5 wt % to about 35 wt % of linoleic acid (C18:2); wherein said wt % is relative to the acids bound as acyl groups in glycerides in the fat composition and based on the total weight of C8 to C24 fatty acids.

The plant-based oil or fat in the fat tissue substitute as disclosed herein preferably has from about 35 wt % to about 60 wt % of saturated fatty acids (SAFA), more preferably from about 40 wt % to about 55 wt % and even more preferably from about 45 wt % to about 50 wt %; wherein said wt % is relative to the acids bound as acyl groups in glycerides in the plant-based oil or fat and based on the total weight of C8 to C24 fatty acids.

The plant-based oil or fat in the fat tissue substitute as disclosed herein preferably has from about 5 wt % to about 50 wt % of monounsaturated fatty acids (MUFA), more preferably from about 10 wt % to about 45 wt % and even more preferably from about 12 wt % to about 42 wt %; wherein said wt % is relative to the acids bound as acyl groups in glycerides in the plant-based oil or fat and based on the total weight of C8 to C24 fatty acids.

The plant-based oil or fat in the fat tissue substitute as disclosed herein preferably has from about 2 wt % to about 45 wt % of polyunsaturated fatty acids (PUFA), more preferably from about 3 wt % to about 40 wt % and even more preferably from about 5 wt % to about 35 wt %; wherein said wt % is relative to the acids bound as acyl groups in glycerides in the plant-based oil or fat and based on the total weight of C8 to C24 fatty acids.

The plant-based oil or fat in the fat tissue substitute as disclosed herein preferably has less than about 2.5 wt % of trans fatty acids (TRANS), more preferably less than about 2.0 wt % and even more preferably less than about 1.5 wt %; wherein said wt % is relative to the acids bound as acyl groups in glycerides in the plant-based oil or fat and based on the total weight of C8 to C24 fatty acids.

The plant-based oil or fat in the fat tissue substitute as disclosed herein preferably has an iodine value (IV) of from about 35 to about 90, more preferably from about 40 to about 85 and even more preferably from about 45 to about 80. The term “iodine value” refers to the number of grams of iodine that could be added to 100 grams of oil. Iodine value is calculated according to AOCS Cd 1c-85, based on total acids bound as acyl groups in glycerides in the fat composition, based on the total weight of C8 to C24 fatty acids.

In a preferred aspect, the plant-based oil or fat in the fat tissue substitute as disclosed herein preferably comprises an interesterified blend of a liquid oil and a fully hydrogenated liquid oil. The interesterification may be carried out chemically or enzymatically. The term “liquid oil” refers to any oil which is liquid or fluid at room temperature (such as from 20° C. to 25° C.). Non-limiting examples of liquid oils include sunflower oil, high oleic sunflower oil, high stearic high oleic sunflower oil, high oleic rapeseed oil, high oleic canola oil, high oleic soybean oil, rapeseed oil, rice oil, soybean oil, chia oil, flaxseed oil, corn oil, safflower oil, olive oil, canola oil, grapeseed oil, pumpkin oil, sesame oil, walnut oil, hazelnut oil, coconut oil, palm olein, a fraction thereof and a mixture thereof. In a more preferred aspect, the plant-based oil or fat in the fat tissue substitute as disclosed herein preferably comprises an interesterified blend of from about 50 wt % to about 70 wt % of a liquid oil and from about 30 wt % to about 50 wt % of a fully hydrogenated liquid oil, relative to the total weight of the plant-based oil or fat in the fat tissue substitute as disclosed herein. In an even more preferred aspect, the plant-based oil or fat in the fat tissue substitute as disclosed herein preferably comprises an interesterified blend of from about 55 wt % to about 65 wt % of soybean oil and from about 35 wt % to about 45 wt % of fully hydrogenated soybean oil, relative to the total weight of the plant-based oil or fat in the fat tissue substitute as disclosed herein. In a most preferred aspect, the plant-based oil or fat in the fat tissue substitute as disclosed herein preferably consists of an interesterified blend of from about 55 wt % to about 65 wt % of soybean oil and from about 35 wt % to about 45 wt % of fully hydrogenated soybean oil, relative to the total weight of the plant-based oil or fat in the fat tissue substitute as disclosed herein.

In another preferred aspect, the plant-based oil or fat in the fat tissue substitute as disclosed herein is preferably selected from a group consisting of cocoa butter, shea butter, palm oil, illipe butter, mango oil, sal butter, kokum oil, coconut oil, palm kernel oil, a fraction thereof and a mixture thereof. In another more preferred aspect, the plant-based oil or fat in the fat tissue substitute as disclosed herein comprises from about 50 wt % to about 100 wt % of shea butter and from 0 wt % to about 50 wt % of shea olein, relative to the total weight of the plant-based oil or fat in the fat tissue substitute as disclosed herein. In another even more preferred aspect, the plant-based oil or fat in the fat tissue substitute as disclosed herein consists of about 100 wt % of shea butter relative to the total weight of the plant-based oil or fat in the fat tissue substitute as disclosed herein.

The fat tissue substitute as disclosed herein preferably comprises from about 0.2 wt % to about 5 wt % of the emulsifier relative to the total weight of the fat tissue substitute, more preferably from about 0.5 wt % to about 3 wt % and even more preferably from about 1 wt % to about 2.5 wt %.

The emulsifier in the fat tissue substitute as disclosed herein is preferably selected from a group consisting of lecithin, hydrolyzed lecithin, hydroxylated lecithin, monoglyceride of fatty acids, diglyceride of fatty acids, polyglyceride of fatty acid, polysorbate, propylene glycol ester, derives thereof and mixtures thereof. The emulsifier in the fat tissue substitute as disclosed herein is more preferably lecithin. Non-limiting examples of suitable sources of lecithin include soybean, canola, cottonseed and sunflower. In some aspects, the lecithin may be de-oiled. Even more preferably, the emulsifier in the fat tissue substitute as disclosed herein is soy lecithin or sunflower lecithin.

In a preferred aspect, the fat tissue substitute as disclosed herein preferably comprises from about 0.2 wt % to about 5 wt % of the emulsifier relative to the total weight of the fat tissue substitute, wherein the emulsifier is selected from a group consisting of lecithin, hydroxylated lecithin, monoglyceride of fatty acids, diglyceride of fatty acids, polyglyceride of fatty acid, polysorbate, propylene glycol ester, derives thereof and mixtures thereof.

In a more preferred aspect, the fat tissue substitute as disclosed herein preferably comprises from about 0.5 wt % to about 3 wt % of the emulsifier relative to the total weight of the fat tissue substitute, wherein the emulsifier is lecithin.

In an even more preferred aspect, the fat tissue substitute as disclosed herein preferably comprises from about 1 wt % to about 2.5 wt % of the emulsifier relative to the total weight of the fat tissue substitute, wherein the emulsifier is soy lecithin.

In a preferred aspect, the weight ratio of the starch source and the emulsifier in the fat tissue substitute as disclosed herein is from about 1:1 to about 3:1.

The fat tissue substitute as disclosed herein preferably comprises from about 15 wt % to about 45 wt % of water relative to the total weight of the fat tissue substitute, more preferably from about 20 wt % to about 40 wt % and even more preferably from about 25 wt % to about 35 wt %.

In a preferred aspect, the fat tissue substitute as disclosed herein comprises (i) from about 0.5 wt % to about 5 wt % of the starch source relative to the total weight of the fat tissue substitute; (ii) less than about 0.5 wt % of the plant-based protein relative to the total weight of the fat tissue substitute; (iii) from about 55 wt % to about 80 wt % of the plant-based oil or fat relative to the total weight of the fat tissue substitute; (iv) from about 0.2 wt % to about 5 wt % of the emulsifier relative to the total weight of the fat tissue substitute; and (v) from about 15 wt % to about 45 wt % of water relative to the total weight of the fat tissue substitute.

In a more preferred aspect, the fat tissue substitute as disclosed herein comprises (i) from about 1 wt % to about 4 wt % of the starch source relative to the total weight of the fat tissue substitute; (ii) less than about 0.2 wt % of the plant-based protein relative to the total weight of the fat tissue substitute; (iii) from about 60 wt % to about 75 wt % of the plant-based oil or fat relative to the total weight of the fat tissue substitute; (iv) from about 0.5 wt % to about 3 wt % of the emulsifier relative to the total weight of the fat tissue substitute; and (v) from about 20 wt % to about 35 wt % of water relative to the total weight of the fat tissue substitute.

In an even more preferred aspect, the fat tissue substitute as disclosed herein comprises (i) from about 1.5 wt % to about 3 wt % of the starch source relative to the total weight of the fat tissue substitute; (ii) less than about 0.1 wt % of the plant-based protein relative to the total weight of the fat tissue substitute; (iii) from about 65 wt % to about 70 wt % of the plant-based oil or fat relative to the total weight of the fat tissue substitute; (iv) from about 1 wt % to about 2.5 wt % of the emulsifier relative to the total weight of the fat tissue substitute; and (v) from about 25 wt % to about 35 wt % of water relative to the total weight of the fat tissue substitute.

The fat tissue substitute as disclosed herein is preferably an oil-in-water emulsion.

In a preferred aspect, the fat tissue substitute as disclosed herein comprises (i) from about 0.5 wt % to about 5 wt % of the starch source relative to the total weight of the fat tissue substitute wherein the starch source is selected from a group consisting of tapioca starch, tapioca flour, corn starch, corn flour, potato starch, pea starch, saga starch, rice flour, rice starch, wheat starch, wheat flour, mung bean starch, mung bean flour, sweet potato starch, modified starch, and combinations thereof; (ii) less than about 0.5 wt % of the plant-based protein relative to the total weight of the fat tissue substitute; (iii) from about 55 wt % to about 80 wt % of the plant-based oil or fat relative to the total weight of the fat tissue substitute wherein the plant-based oil or fat has a solid fat content (SFC) from 28 to 60 solid fat content at 10.0° C.; an SFC from 18 to 40 at 21.1° C.; an SFC from 5 to 30 at 26.7° C.; an SFC from 3 to 22 at 33.3° C.; and an SFC from 0.5 to 15 at 40.0° C.; wherein the solid fat content is measured on unstabilized fat according to AOCS Cd 16b-93; from about 3 wt % to about 20 wt % of palmitic acid (C16:0); from about 15 wt % to about 55 wt % of stearic acid (C18:0); from about 5 wt % to about 55 wt % of oleic acid (C18:1); and from about 3 wt % to about 45 wt % of linoleic acid (C18:2); wherein said wt % is relative to the acids bound as acyl groups in glycerides in the fat composition and based on the total weight of C8 to C24 fatty acids; (iv) from about 0.2 wt % to about 5 wt % of the emulsifier relative to the total weight of the fat tissue substitute wherein the emulsifier is selected from a group consisting of lecithin, hydroxylated lecithin, monoglyceride of fatty acids, diglyceride of fatty acids, polyglyceride of fatty acid, polysorbate, propylene glycol ester, derives thereof and mixture thereof; and (v) from about 15 wt % to about 45 wt % of water relative to the total weight of the fat tissue substitute; wherein the fat tissue substitute is an oil-in-water emulsion.

In a more preferred aspect, the fat tissue substitute as disclosed herein comprises (i) from about 1 wt % to about 4 wt % of the starch source relative to the total weight of the fat tissue substitute wherein the starch source is selected from a group consisting of tapioca starch, corn starch, corn flour, potato starch, and combination thereof; (ii) less than about 0.2 wt % of the plant-based protein relative to the total weight of the fat tissue substitute; (iii) from about 60 wt % to about 75 wt % of the plant-based oil or fat relative to the total weight of the fat tissue substitute wherein the plant-based oil or fat has a solid fat content (SFC) from 32 to 55 at 10.0° C.; an SFC from 20 to 35 at 21.1° C.; an SFC from 6 to 25 at 26.7° C.; an SFC from 4 to 18 at 33.3° C.; and an SFC from 1 to 12 at 40.0° C.; wherein the solid fat content is measured on unstabilized fat according to AOCS Cd 16b-93; from about 4 wt % to about 15 wt % of palmitic acid (C16:0); from about 20 wt % to about 50 wt % of stearic acid (C18:0); from about 8 wt % to about 50 wt % of oleic acid (C18:1); and from about 4 wt % to about 40 wt % of linoleic acid (C18:2); wherein said wt % is relative to the acids bound as acyl groups in glycerides in the fat composition and based on the total weight of C8 to C24 fatty acids; (iv) from about 0.5 wt % to about 3 wt % of the emulsifier relative to the total weight of the fat tissue substitute wherein the emulsifier is lecithin; and (v) from about 20 wt % to about 35 wt % of water relative to the total weight of the fat tissue substitute; wherein the fat tissue substitute is an oil-in-water emulsion.

In an even more preferred aspect, the fat tissue substitute as disclosed herein comprises (i) from about 1.5 wt % to about 3 wt % of the starch source relative to the total weight of the fat tissue substitute wherein the starch source is pregelatinized corn starch; (ii) less than about 0.1 wt % of the plant-based protein relative to the total weight of the fat tissue substitute; (iii) from about 65 wt % to about 70 wt % of the plant-based oil or fat relative to the total weight of the fat tissue substitute wherein the plant-based oil or fat has a solid fat content (SFC) from 35 to 50 at 10.0° C.; an SFC from 21 to 30 at 21.1° C.; an SFC from 8 to 22 at 26.7° C.; an SFC from 4 to 15 at 33.3° C.; and an SFC from 1.5 to 10 at 40.0° C.; wherein the solid fat content is measured on unstabilized fat according to AOCS Cd 16b-93; from about 4 wt % to about 12 wt % of palmitic acid (C16:0); from about 25 wt % to about 45 wt % of stearic acid (C18:0); from about 10 wt % to about 45 wt % of oleic acid (C18:1); and from about 5 wt % to about 35 wt % of linoleic acid (C18:2); wherein said wt % is relative to the acids bound as acyl groups in glycerides in the fat composition and based on the total weight of C8 to C24 fatty acids; (iv) from about 1 wt % to about 2.5 wt % of the emulsifier relative to the total weight of the fat tissue substitute wherein the emulsifier is soy lecithin; and (v) from about 25 wt % to about 35 wt % of water relative to the total weight of the fat tissue substitute; wherein the fat tissue substitute is an oil-in-water emulsion.

In another even more preferred aspect, the fat tissue substitute as disclosed herein comprises (i) from about 1.5 wt % to about 3 wt % of the starch source relative to the total weight of the fat tissue substitute wherein the starch source is selected from a group consisting of corn starch, corn flour, derivatives thereof and mixtures thereof; (ii) less than about 0.1 wt % of the plant-based protein relative to the total weight of the fat tissue substitute; (iii) from about 65 wt % to about 70 wt % of the plant-based oil or fat relative to the total weight of the fat tissue substitute wherein the plant-based oil or fat has a solid fat content (SFC) from 35 to 50 at 10.0° C.; an SFC from 21 to 30 at 21.1° C.; an SFC from 8 to 22 at 26.7° C.; an SFC from 4 to 15 at 33.3° C.; and an SFC from 1.5 to 10 at 40.0° C.; wherein the solid fat content is measured on unstabilized fat according to AOCS Cd 16b-93; from about 4 wt % to about 12 wt % of palmitic acid (C16:0); from about 25 wt % to about 45 wt % of stearic acid (C18:0); from about 10 wt % to about 45 wt % of oleic acid (C18:1); and from about 5 wt % to about 35 wt % of linoleic acid (C18:2); wherein said wt % is relative to the acids bound as acyl groups in glycerides in the fat composition and based on the total weight of C8 to C24 fatty acids; (iv) from about 1 wt % to about 2.5 wt % of the emulsifier relative to the total weight of the fat tissue substitute wherein the emulsifier is soy lecithin; and (v) from about 25 wt % to about 35 wt % of water relative to the total weight of the fat tissue substitute; wherein the fat tissue substitute is an oil-in-water emulsion.

The fat tissue substitute as disclosed herein preferably comprises one or more ingredients selected from the group consisting of alginate, methylcellulose, antimicrobial, antioxidant, enzyme, fibre, salt, carrageenan, gum, flavor and colorant.

In a preferred aspect, the fat tissue substitute as disclosed herein further comprises oat fibre. In a more preferred aspect, the fat tissue substitute as disclosed herein further comprises from 0.1 wt % to 3 wt % oat fibre relative to the total weight of the fat tissue substitute. In an even more preferred aspect, the fat tissue substitute as disclosed herein further comprises from 0.3 wt % to 1 wt % oat fibre relative to the total weight of the fat tissue substitute.

In a preferred aspect, the fat tissue substitute as disclosed herein further comprises oat fibre, wherein the weight ratio between the starch source and oat fibre is from about 2.5:1 to about 3.5:1. In a more preferred aspect, the fat tissue substitute as disclosed herein comprises tapioca starch and oat fibre, wherein the weight ratio between the starch source and oat fibre is from about 2.5:1 to about 3.5:1.

### Process of Making a Fat Tissue Substitute

In another aspect, the present disclosure is directed to a process for making the fat tissue substitute as disclosed herein, the process comprising the steps of: a) providing a starch source, a plant-based oil or fat, an emulsifier, optionally a plant-based protein; b) forming a mixture with the provided ingredients and water; c) emulsifying the mixture to obtain an emulsion; and d) crystallizing the obtained emulsion.

In a preferred aspect, the process as disclosed herein is carried out by votation equipment equipped with scaped surface heat exchanger (SSHE). In a more preferred aspect, the process as disclosed herein is carried out by votation equipment including two scraped surface heat exchanger units and one pin-rotor machine. In an even more preferred aspect, the process as disclosed herein is carried out by votation equipment including two scrapped surface heat exchanger units and one pin-rotor machine, having the following configuration: the first scrapped surface heat exchanger unit is operated at a temperature of from about 25° C. to about 35° C.; and/or the second scrapped surface heat exchanger unit is operated at a temperature of from about 15° C. to about 25° C.; and/or the pin-rotor machine is operated at a temperature of from about 20° C. to about 30° C.

### Method of Using a Fat Tissue Substitute

In a further aspect, the present disclosure is directed to a use of the fat tissue substitute as disclosed herein in a food product. In a further preferred aspect, the present disclosure is directed to a use of the fat tissue substitute as disclosed herein in a food product selected from the group consisting of plant-based meat, plant-based bacon, plant-based burger, plant-based cold cut, plant-based sausage, plant-based patty, plant-based chicken, plant-based fish, and combinations thereof.

In another aspect, the present disclosure is directed to a food product comprising the fat tissue substitute as disclosed herein. In a further preferred aspect, the present disclosure is directed to a food product selected from the group consisting of plant-based meat, plant-based bacon, plant-based burger, plant-based cold cut, plant-based sausage, plant-based patty, plant-based chicken, plant-based fish, and combinations thereof, comprising the fat tissue substitute as disclosed herein.

In a preferred aspect, the food product as disclosed herein comprises from about 1 wt % to about 80 wt % of the fat tissue substitute as disclosed herein, relative to the total weight of the food product, more preferably from about 1 wt % to about 60 wt % and even more preferably from about 5 wt % to about 50 wt %.

### EXAMPLES

The following non-limiting examples illustrate the invention and do not limit its scope in any way, as many variations of the present invention are possible without departing from its spirit or scope. In the examples and throughout this specification, all percentages, parts and ratios are by weight unless indicated otherwise.

### Example 1

Three fat compositions were prepared to evaluate their properties and potential applications. Fat composition 1 was an enzymatically interesterified blend of 60 wt % soybean oil and 40 wt % fully hydrogenated soybean oil. Fat composition 2 was 100% refined shea butter. Fat composition 3 was a blend of 62 wt % refined shea olein and 38 wt % refined shea butter. The analytical data characterizing these fat compositions is presented below in Table 1.

TABLE 1
Analytical results of fat compositions 1, 2 and 3

| | Fat composition 1 | Fat composition 2 | Fat composition 3 |
|---|---|---|---|
| C8:0 | 0.0 | 0.0 | 0.0 |
| C10:0 | 0.0 | 0.0 | 0.0 |
| C12:0 | 0.0 | 0.0 | 0.9 |
| C14:0 | 0.1 | 0.2 | 0.4 |
| C16:0 | 12.0 | 4.9 | 5.9 |
| C16:1 | 0.2 | 0.1 | 0.1 |
| C17:0 | 0.0 | 0.0 | 0.1 |
| C18:0 | 36.4 | 44.1 | 36.4 |
| C18:1 | 14.4 | 42.9 | 47.5 |
| C18:2 | 31.5 | 5.6 | 6.8 |
| C18:3 | 2.9 | 0.1 | 0.1 |
| C20:0 | 0.4 | 1.5 | 1.3 |
| C20:1 | 0.6 | 0.2 | 0.0 |
| C22:0 | 0.3 | 0.1 | 0.1 |
| C22:1 | 0.0 | 0.0 | 0.0 |
| C24:0 | 0.1 | 0.1 | 0.1 |
| SAFA | 46.4 | 47.8 | 42.5 |
| MUFA | 14.2 | 40.7 | 44.8 |
| PUFA | 32.3 | 5.4 | 6.5 |
| TRANS | 1.1 | 0.0 | 0.2 |
| IV | 77.4 | 47.2 | 53.5 |
| SFC-10.0° C. | 36.3 | 48.7 | 28.1 |
| SFC-21.1° C. | 26.6 | 21.4 | 10.7 |
| SFC-26.7° C. | 20.4 | 8.5 | 4.1 |
| SFC-33.3° C. | 15.0 | 4.4 | 1.3 |
| SFC-40.0° C. | 9.7 | 1.8 | 0.1 |

In the above table, the fatty acid composition of the fat components is detailed using the Cx:y notation, where x represents the number carbon atoms and y represents the number of double bonds within the fatty acid chain. These values were determined by gas chromatography-fatty acid methyl ester analysis (GC-FAME) following the ISO standards 12966-2: 2014 and 12966-4: 2015). Additionally, the table provides information on the proportion of saturated (SAFA), monounsaturated (MUFA) and polyunsaturated (PUFA) fatty acids, along with the calculated iodine value (IV) as per AOCS Cd 1c-85, and the amount of Trans fatty acids (TRANS), or unsaturated fatty acids having a double bond in a trans arrangement. The solid fat content (SFC, wt %) at a given temperature, measured by NVR on unstabilised fat measured at the provided temperature according to AOCS Cd 16b-93, is also included.

These fat compositions were used to develop three plant-based intramuscular fat replacer products: Product 1, Product 2, and Comparative Product 1. The specific formulations for each product are detailed below in Table 2.

TABLE 2
Formulations of Product 1, Product 2, and Comparative Product 1

| | | | Comparative |
|---|---|---|---|
| | Product 1 | Product 2 | Product 1 |
| Ingredient | Weight % | Weight % | Weight % |
| Tapioca Starch | 1.5 | 1.5 | 1.5 |
| Oat fiber | 0.5 | 0.5 | 0.5 |
| Soy protein | * | * | 2.0 |
| concentrate | | | |
| Water | 30.0 | 30.0 | 30.0 |
| Soy lecithin | 1.5 | 1.5 | 1.5 |
| Fat composition 1 | 66.5 | * | * |
| Fat composition 2 | * | 66.5 | * |
| Fat composition 3 | * | * | 64.5 |
| Total | 100.0 | 100.0 | 100.0 |

Tapioca starch was commercially sourced from Ingredion (Westchester, IL), oat fiber from J. Rettenmaier USA LP (Schoolcraft, MI), and both soy protein concentrate and soy lecithin from Bunge (Chesterfield, MO).

Following the formulations outlined in Table 2, Product 1, Product 2, and Comparative Product 1 were prepared using a bench-top propeller mixer and an ice cream freezer. The ingredients were first blended together before being mixed at 700 rpm with the propeller mixer to form emulsions. These emulsions were then processed in an ice cream freezer to induce crystallization and solidification, resulting in the final products.

Immediately after processing, Product 1, Product 2 and Comparative Product 1 were evaluated. Product 1 and Product 2 exhibited desirable textural qualities, demonstrating firmness and plasticity. However, Comparative Product 1 was soft to touch and did not set firmly.

Following overnight storage at room temperature (21.1° C.), Product 1 and Product 2 maintained their structural integrity. However, Comparative Product 1 showed signs of instability, with a clear separation of the oil and water phases, indicating emulsion breakage.

### Example 2

An additional plant-based intramuscular fat replacer product, designated as Product 3, was prepared. The specific formulation for this product is presented below in Table 3.

TABLE 3
Formulations of Product 3

| | Product 3 |
|---|---|
| Ingredient | Weight % |
| Pregelatinized corn flour | 2.0 |
| Water | 30.0 |
| Soy lecithin | 1.5 |
| Fat composition 1 | 66.5 |
| Total | 100.0 |

Both pregelatinized corn flour, primarily composed of starch, and soy lecithin were obtained from Bunge (Chesterfield, MO).

The pregelatinized corn flour was mixed with water in a side kettle and heated to 73.9° C. to form the aqueous phase. Consequently, the prepared Fat Composition 1 (as described in Example 1) and soy lecithin were melted and mixed inside a premix tank. While continuously mixing, the aqueous phase was gradually added to the melted fat and lecithin mixture, resulting in a stable and creamy oil-in-water emulsion. This emulsion was then ready for further processing and crystallization.

The prepared emulsion was pumped to a votation line containing two scraped surface heat exchanger units and a pin-rotor machine. The specific conditions used during the votation process are detailed in Table 4.

TABLE 4
Votation conditions to produce Product 3

| | | |
|---|---|---|
| Feed Temperature | 59.5° | C. |
| 1^{st} Crystallization temperature | 30.6° | C. |
| 2^{nd} Crystallization temperature | 20° | C. |
| Pin worker temperature | 25.4° | C. |
| Remelt temperature | 60° | C. |
| 1^{st} Crystallization pump speed | 450 | rpm |
| 2^{nd} Crystallization pump speed | 450 | rpm |
| Pin worker pump speed | 150 | rpm |

Product 3 was stored overnight at two different temperatures: 4.4° C. and −17.8° C. A mechanical cheese shredder (Robot Coupe R2N Commercial Food Processor with RG2 Grater Plate, 2 mm thickness) was used to shred the product into pieces suitable for incorporating into plant-based meat dough as marbling fat. Product 3 stored at −17.8° C. shredded exceptionally easily, while Product 3 stored at 4.4° C. also shredded well with only a slight tendency to clump. Overall, Product 3 demonstrated ease of size reduction into small particles or pieces while maintaining a stable emulsion.

The shredded Product 3 was then mixed into plant-based burger dough and pressed into patties. The marbling fat pieces retained well-defined shapes. For comparison, a reference batch of plant-based burger dough was prepared using frozen shavings of coconut oil as the marbling fat. Both sets of patties were cooked on a griddle at 176.7° C. for 3 minutes per side or until reaching an internal temperature of 73.9° C.

During cooking, the reference patties with coconut oil exhibited significant oil leakage onto the griddle, an undesirable characteristic. In addition, small pockets or voids were visible on the surface of the cooked reference patties.

In contrast, the plant-based burgers incorporating shredded Product 3 (stored at either temperature) showed minimal oil release and produced a desirable sizzling sound during cooking, akin to cooking a meat-based burger. Furthermore, these patties developed a crispy crust and did not stick to the cooking surface.

These observations demonstrate the suitability of the plant-based intramuscular fat replacer as disclosed herein, exemplified by Product 3, for use as marbling fat in plant-based meat applications. Its incorporation effectively enhances marbling appearance, juiciness, sizzling, and reduction of oil leakage.

### Example 3

Five additional plant-based intramuscular fat replacer products were developed (Products 4, 5, 6, 7 and 8). The formulations for these products, detailing their ingredient compositions, are outlined in Table 5 below.

TABLE 5
Formulations of Products 4 to 8

| | Product 4 | Product 5 | Product 6 | Product 7 | Product 8 |
|---|---|---|---|---|---|
| Ingredient | Weight % | Weight % | Weight % | Weight % | Weight % |
| Potato starch | 2.0 | 2.0 | * | * | * |
| Corn flour | * | * | 2.0 | 2.0 | * |
| Modified | * | * | * | * | 2.0 |
| corn starch | | | | | |
| Water | 30.0 | 30.0 | 30.0 | 30.0 | 30.0 |
| Soy lecithin | 1.5 | 1.5 | 1.5 | 1.5 | 1.5 |
| Fat composi- | 66.5 | * | 66.5 | * | * |
| tion 1 | | | | | |
| Fat composi- | * | 66.5 | * | 66.5 | 66.5 |
| tion 2 | | | | | |
| Total | 100.0 | 100.0 | 100.0 | 100.0 | 100.0 |

Potato starch was commercially sourced from Avebe (Netherlands), modified corn starch from Ingredion (Westchester, IL), and both corn flour (primarily starch with minor components such as fiber, obtained by grinding dried corn kernels into a fine powder) and soy lecithin from Bunge (Chesterfield, MO).

Products 4 to 8 were produced following the same procedure as described in Example 2. The obtained products were stored overnight at −17.8° C. and subsequently shredded using a mechanical cheese shredder (Robot Coupe R2N Commercial Food Processor with RG2 Grater Plate, 2 mm thickness).

After shredding, the product pieces were placed on a plate and kept in a freezer at −17.8° C. overnight. They were then thawed at room temperature (about 21.1° C.) for 2 hours. This freeze/thaw cycle was repeated once more.

Throughout the freeze/thaw cycles, the product shreds maintained their emulsion stability, retaining their original appearance and form. At −17.8° C., the shreds were solid and very firm, while 21.1° C., they softened and became slightly sticky. The observed stability of the products during freeze/thaw cycles demonstrates their resilience, stability, and suitability for plant-based food processes where such temperature fluctuations are common.

The listing or discussion of an apparently prior-published document in this specification should not necessarily be taken as an acknowledgement that the document is part of the state of the art or is common general knowledge.

Preferences and options for a given aspect, embodiment, feature or parameter of the invention should, unless the context indicates otherwise, be regarded as having been disclosed in combination with any and all preferences and options for all other aspects, embodiments, features and parameters of the invention.

As will be understood by one skilled in the art, for any and all purposes, particularly in terms of providing a written description, all ranges disclosed herein also encompass any and all possible subranges and combinations of subranges thereof. Any listed ranges can be easily recognized as sufficiently describing and enabling the same range being broken down into at least equal halves, thirds, quarters, fifths, tenths, etc. As will also be understood by one skilled in the art all language such as “up to”, “at least”, “greater than”, “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

1. A fat tissue substitute characterized in that the fat tissue substitute is plant-based and comprises:
(i) a starch source;
(ii) less than 1 wt % of a plant-based protein relative to the total weight of the fat tissue substitute;
(iii) a plant-based oil or fat having:
a) a solid fat content from 15 to 45 at 21.1° C., and
b) a solid fat content from 2 to 25 at 33.3° C.; wherein the solid fat content is measured on unstabilized fat according to AOCS Cd 16b-93;
(iv) an emulsifier; and
(v) water.

2. The fat tissue substitute according to claim 1, comprising from 0.5 wt % to 5 wt % of the starch source relative to the total weight of the fat tissue substitute.

3. The fat tissue substitute according to claim 1, wherein the starch source is selected from a group consisting of tapioca starch, tapioca flour, corn starch, corn flour, potato starch, pea starch, saga starch, rice flour, rice starch, wheat starch, wheat flour, mung bean starch, mung bean flour, sweet potato starch, modified starch, and combinations thereof.

4. The fat tissue substitute according to claim 1, comprising less than 0.5 wt % of the plant-based protein relative to the total weight of the fat tissue substitute.

5. The fat tissue substitute according to claim 1, comprising from 55 wt % to 80 wt % of the plant-based oil or fat relative to the total weight of the fat tissue substitute, preferably from 60 wt % to 75 wt % and more preferably from 65 wt % to 70 wt %.

6. The fat tissue substitute according to claim 1, wherein the plant-based oil or fat of the fat tissue substitute has:
(i) from 32 to 55 solid fat content at 10.0° C.; and/or
(ii) from 20 to 35 solid fat content at 21.1° C.; and/or
(iii) from 5 to 30 solid fat content at 26.7° C.; and/or
(iv) from 4 to 18 solid fat content at 33.3° C.; and/or
(v) from 0.5 to 15 solid fat content at 40.0° C.;
wherein the solid fat content is measured on unstabilized fat according to AOCS Cd 16b-93.

7. The fat tissue substitute according to claim 1, wherein the plant-based oil or fat of the fat tissue substitute has:
(i) from 3 wt % to 20 wt % of palmitic acid (C16:0); and/or
(ii) from 15 wt % to 55 wt % of stearic acid (C18:0); and/or
(iv) from 3 wt % to 45 wt % of linoleic acid (C18:2);
wherein said wt % is relative to the acids bound as acyl groups in glycerides in the fat composition and based on the total weight of C8 to C24 fatty acids.

8. The fat tissue substitute according to claim 1, comprising from 0.2 wt % to 5 wt % of the emulsifier relative to the total weight of the fat tissue substitute.

9. The fat tissue substitute according to claim 1, wherein the emulsifier is selected from a group consisting of lecithin, hydroxylated lecithin, monoglyceride of fatty acids, diglyceride of fatty acids, polyglyceride of fatty acid, polysorbate, propylene glycol ester, derivatives thereof and mixtures thereof.

10. The fat tissue substitute according to claim 1, comprising from 15 wt % to 45 wt % of water relative to the total weight of the fat tissue substitute.

11. The fat tissue substitute according to claim 1, wherein the fat tissue substitute is an oil-in-water emulsion.

12. The fat tissue substitute according to claim 1, further comprising one or more ingredients selected from the group consisting of alginate, methylcellulose, antimicrobial, antioxidant, enzyme, fibre, salt, carrageenan, gum, flavor and colorant.

13. Process for making a fat tissue substitute according to claim 1, the process comprising the steps of:
a) providing a starch source, a plant-based oil or fat, an emulsifier, and optionally a plant-based protein;
b) forming a mixture of the provided ingredients and water;
c) emulsifying the mixture to obtain an emulsion; and
d) crystallizing the obtained emulsion.

14. Use of a fat tissue substitute according to claim 1 in a food product.

15. A food product comprising a fat tissue substitute according to claim 1.
